(19) United States
(12) Patent Application Publication
(10) Pub. No.: US 2026/0239265 A1
(43) Pub. Date: Aug. 13, 2026

(54) SYSTEMS AND METHODS FOR POLICY ASSOCIATION CREATION DURING INTER-SYSTEM MOBILITY

(71) Applicant: Verizon Patent and Licensing Inc., Basking Ridge, NJ (US)

(72) Inventors: Helen Osias Eglip, Sammamish, WA (US); Maqbool Chauhan, Keller, TX (US); Jerry Steben, Fort Worth, TX (US); Lixia Yan, Basking Ridge, NJ (US); Tony Ferreira, Greenwich, CT (US)

(21) Appl. No.: 19/051,575

(22) Filed: Feb. 12, 2025

(51) Int. Cl. H04W 60/06; H04M 15/00; H04W 76/19

(52) U.S. Cl. CPC H04W 60/06; H04M 15/66; H04W 76/19

(57) ABSTRACT

A method may include receiving, by a first access and mobility management function (AMF), a first message associated with a de-registration of a user equipment (UE) device from a first network and maintaining policy association information associated with the UE device and the first network. The method may also include receiving, by the first AMF or a second AMF and within a predetermined period of time after the first message is received, a second message indicating that the UE device is re-connecting with the first network. The method may further include modifying, in response to the first AMF receiving the second message, the policy association information to indicate that the policy association information is active.

### BACKGROUND INFORMATION

In Fifth Generation (5G) network environments established in accordance with the 3rd Generation Partnership Project (3GPP), a registration procedure is defined for a user equipment (UE) device attempting to attach to the network. The registration procedures often include generating a UE device policy association and an access and mobility (AM) policy association for the network connection. When the UE device is mobile, the UE device may move, for example, from an area in which a 5G connection is available to an area in which only a Fourth Generation (4G) connection is available Such inter-system movement will trigger UE policy association and AM policy association termination procedures associated with the 5G network connection.

### BRIEF DESCRIPTION OF THE DRAWINGS

FIG. 1 illustrates an exemplary environment in which systems and methods described herein may be implemented;

FIG. 2 is a block diagram of components implemented in the environment of FIG. 1 in accordance with an exemplary implementation;

FIG. 3 illustrates logic components implemented in one or more of the devices illustrated in FIGS. 1 and 2 in accordance with an exemplary implementation;

FIGS. 4A and 4B are flow diagrams illustrating processing associated with establishing and maintaining UE and AM policy associations in accordance with an exemplary implementation; and

FIG. 5 is an exemplary signal flow diagram associated with the processing of FIGS. 4A and 4B.

### DETAILED DESCRIPTION OF EXAMPLE EMBODIMENTS

The following detailed description refers to the accompanying drawings. The same reference numbers in different drawings may identify the same or similar elements.

Implementations described herein provide for the establishment and maintaining of an AM policy association and a UE policy association for UE devices that may be switching from one network connection to another network connection. For example, in one implementation, a moving UE device may switch from a 5G system (5GS)/network connection to an evolved packet system (EPS)/network connection, such as a 4G Long Term Evolution (LTE) network connection, and then back to the 5GS/network connection. In this implementation, the UE and AM policy associations established for the 5GS may be flagged as “transient” when the UE switches to the 4G system. If the UE device returns to the 5GS within a period of time, the UE and AM policy associations may be modified to an “active” state.

Marking the UE and AM policy associations as transient, as opposed to terminating the UE and AM policy associations and re-creating the UE and AM policy associations at a later time saves a significant amount of signaling between various network functions (NFs), as well as saves time associated with generating new policy associations.

In another scenario, if a UE device reconnects with the 5GS at a different location (e.g., in an area handled by a different access and mobility management function (AMF), context information associated with the previous 5GS connection and other information associated with the UE and AM policy associations may be transferred to the new AMF. This may also allow the 5GS to save time and signaling associated with re-creating new UE and AM policy associations.

The term “AM policy association” as used herein should be broadly construed to refer to access and mobility policies and policy-related processing. For example, AM policy association may refer to a policy to control service area restrictions (e.g., a list of allowed tracking area identities (TAIs), non-allowed TAIs), a policy that specifies a radio access technology (RAT) frequency selection priority (RFSP) index that defines spectrum permissions to apply to a UE device, a policy that defines a UE aggregate maximum bit rate (AMBR), a policy that defines traffic steering/routing, a policy that defines network slice enablement and other policies, services and/or functionalities associated with access and mobility.

The term “UE policy association” as used herein should be broadly construed to refer to policies and/or associations which are associated with a UE device's data usage, access to network resources, network behavior, etc., including Quality of Service (QoS), Service Level Agreements (SLAs), guaranteed throughput/bit rates, latency requirements, etc., associated with a subscriber or other party associated with a UE device.

The term “transient” as used herein should be broadly construed as any marking or label used to indicate that the data associated with the “transient” label is to be maintained in memory for a period of time, such as a configurable period of time.

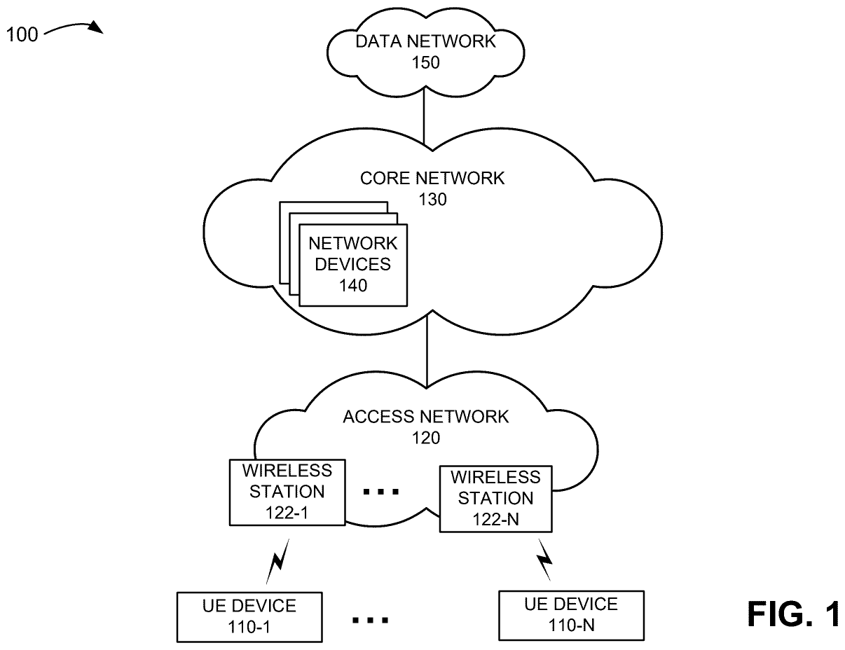

FIG. 1 is a diagram illustrating an exemplary environment 100 in which systems and methods described herein may be implemented. Referring to FIG. 1, environment 100 includes user equipment (UE) devices 110-1 through 110-N, access network 120, wireless stations 122-1 through 122-N, core network 130, network devices 140 and data network 150.

UE devices 110-1 and 110-N (referred to herein individually as UE device or UE 110, and collectively as UE devices or UEs 110) may include any computing device, such as a personal computer (PC), a laptop computer, a server, a tablet computer, a notebook, a Chromebook®, a mobile device, such as wireless or cellular telephone device (e.g., a conventional cell phone with data processing capabilities), a smart phone, a personal digital assistant (PDA) that can include a radiotelephone, any type of mobile computer device or system, a game playing device, a music playing device, a home appliance device, a home monitoring device, a virtualized system, an Internet of Things (IoT) device, a machine type communication (MTC) device, etc., that includes communication functionality. UE device 110-1 may connect to access network 120 via wireless station 122-1 and UE device 110-N may connect to access network 120 via wireless station 122-N. UE devices 110 may also connect to other devices in environment 100 via other techniques, such as wired, wireless, optical connections or a combination of these techniques. UE device 110 and a person that may be associated with UE device 110 (e.g., the party holding or using UE device 110) may be referred to collectively as UE device 110 or UE 110 in the description below.

Access network 120 may provide access to core network 130 for wireless devices, such as UE devices 110. Access network 120 may enable UE device 110 to connect to core network 130 for Internet access, non-Internet Protocol (IP) data delivery, cloud computing, mobile telephone service, Short Message Service (SMS), Multimedia Message Service (MMS), and/or other types of data services. Access network 120 may provide access to core network 130, a service or application layer network, a cloud network, a multi-access edge computing (MEC) network, a fog network, etc. Furthermore, access network 120 may enable a device in core network 130 to exchange data with UE device 110 using a non-IP data delivery method such as Data over Non-Access Stratum (DoNAS).

Access network 120 may include a Fifth Generation (5G) access network, Sixth Generation (6G) access network or another advanced access network, such as 4G LTE access network. For example, access network 120 may include the functionality of a 5G network, such as 5G Radio Access Network (RAN) communicating via mmWave technology, a 5G RAN communicating via C-band technology or other types of 5G networks. Access network 120 may also include a 4G RAN.

Access network 120 may also include: support for advanced or massive multiple-input and multiple-output (MIMO) antenna configurations (e.g., an 8×8 antenna configuration, a 16×16 antenna configuration, a 256×256 antenna configuration, etc.); support for cooperative MIMO (CO-MIMO) configurations; support for carrier aggregation; relay stations; Heterogeneous Networks (HetNets) of overlapping small cells and macrocells; Self-Organizing Network (SON) functionality; machine type communication (MTC) functionality, such as 1.4 MHz wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of 5G functionality.

Wireless stations 122 (referred to collectively as wireless stations 122 and individually as wireless station 122) may be included in access network 120. Each wireless station 122 may service a number of UE devices 110 and/or other user devices when the particular device is within radio frequency range of wireless station 122. In one implementation, wireless station 122 may include 5G base station (e.g., a next generation NodeB (gNB)) that includes one or more radio frequency (RF) transceivers. For example, wireless station 122 may include three RF transceivers and each RF transceiver may service a 120 degree sector of a 360 degree field of view. Each RF transceiver may include or be coupled to an antenna array. The antenna array may include an array of controllable antenna elements configured to send and receive 5G new radio (NR) wireless signals via one or more antenna beams. In other implementations, wireless station 122 may also include a 4G base station (e.g., an evolved NodeB (eNodeB)) or a 6G base station that communicates wirelessly with UEs 110 located within the radio frequency range of wireless station 122.

Core network 130 may include one or more wired, wireless and/or optical networks that are capable of receiving and transmitting data, voice and/or video signals. In an exemplary implementation, core network 130 may be associated with a telecommunications service provider (e.g., a service provider providing cellular wireless communication services and wired communication services) and may manage communication sessions of UE devices 110 connecting to core network 130 via access network 120. Core network 130 may include one or multiple networks of different types and technologies. For example, core network 130 may be implemented to include a next generation core (NGC) network for a 5G network, an Evolved Packet Core (EPC) of an LTE or LTE Advanced network, a 6G network, and/or a legacy core network. Core network 130 may provide packet-switched services and wireless IP connectivity to various components in environment 100, such as UE devices 110, to provide, for example, data, voice, and/or multimedia services.

Core network 130 may include various network devices 140. Depending on the implementation, network devices 140 may include 5G core network components (e.g., a User Plane Function (UPF), an Access and Mobility Management Function (AMF), a Session Management Function (SMF), a Unified Data Management (UDM) function, a Unified Data Repository (UDR), a Policy Control Function (PCF), an access management—policy control function (AM-PCF), a session management—policy control function (SM-PCF), a Charging Function (CHF), a network exposure function (NEF), an application function (AF), etc.), 4G core network components (e.g., a Serving Gateway (SGW), a Packet data network Gateway (PGW), a Mobility Management Entity (MME), a Home Subscriber Server (HSS), a Policy Charging and Rules Function (PCRF) etc.), or another type of core network components (e.g., future 6G network components). In other implementation, network devices 140 may include combined 4G and 5G functionality, such as a session management function with PGW-control plane (SMF+PGW-C) and a user plane function with PGW-user plane (UPF+PGW-U).

Data network 150 may include, for example, a packet data network. In an exemplary implementation, UE device 110 may connect to data network 150 via core network 130. Data network 150 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

The exemplary configuration illustrated in FIG. 1 is provided for simplicity. It should be understood that a typical environment may include more or fewer devices than illustrated in FIG. 1. For example, environment 100 may include a large number (e.g., thousands or more) of UE devices 110 and wireless stations 122, as well as multiple access networks 120, core networks 130 and data networks 150. Environment 100 may also include elements such as gateways, monitoring devices, network elements/functions, etc. (not shown), that aid in providing data services and routing data in environment 100.

Various functions are described below as being performed by particular components in environment 100. In other implementations, various functions described as being performed by one device may be performed by another device or multiple other devices, and/or various functions described as being performed by multiple devices may be combined and performed by a single device.

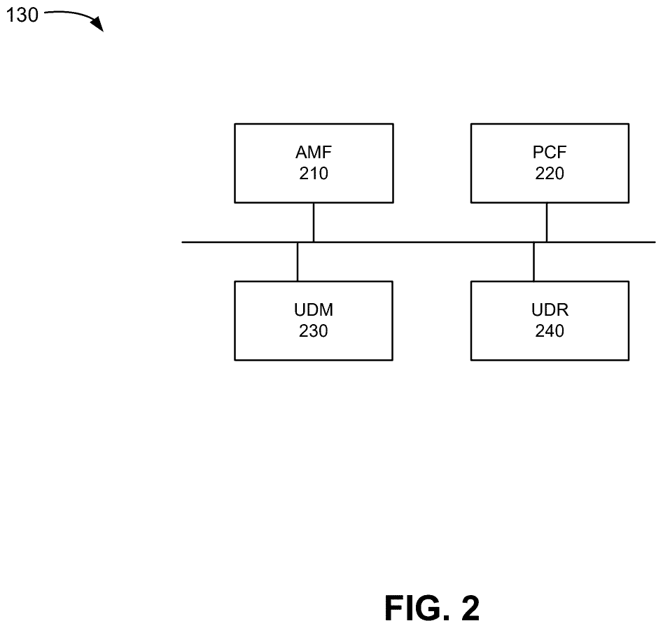

FIG. 2 illustrates a portion of environment 100, including elements implemented in core network 130 in accordance with an exemplary implementation. Referring to FIG. 2, network devices 140 in core network 130 include AMF 210, PCF 220, UDM 230 and UDR 240. It should be understood that core network 130 may include other elements/functions, such as those elements/functions described above with respect to FIG. 1, and/or differently arranged elements. It should also be understood that core network 130 may include large numbers of AMFs 210, PCFs 220, UDMs 230, UDMs 240, etc., distributed in environment 100.

AMF 210 may perform registration management, connection management, reachability management, mobility management, lawful intercepts, Short Message Service (SMS) transport between UE device 110 and other network functions, session management messages transport between UE device 110 and an SMF (not shown), access authentication and authorization, location services management, functionality to support non-3GPP access networks, and/or other types of management processes. In exemplary implementations, AMF 210 may obtain information from other devices, such as UDM 230, UDR 240, a CHF (not shown), etc., and establish an AM policy association and/or a UE policy association for a UE device 110.

PCF 220 may perform policy control functions, as well as some access management functions. For example, PCF 220 may support policies to control network behavior, provide policy rules to control plane functions (e.g., to an SMF, not shown), access subscription information relevant to policy decisions, generate policy decisions, and/or perform other types of processes associated with policy enforcement. In an exemplary implementation, PCF 220 may receive an AM policy association establishment request from AMF 210 during a UE device 110 registration and establish an AM policy association for the UE device 110, as described in detail below. PCF 220 may also receive a UE policy association establishment request from AMF 210 during a UE device registration and establish a UE policy association for the UE device 110, as described in detail below.

UDM 230 may maintain subscription information for UE devices 110, manage subscriptions, generate authentication credentials, handle user identification, perform access authorization based on subscription data, perform network function registration management, maintain service and/or session continuity by maintaining assignment of an SMF (not shown) for ongoing sessions, support SMS delivery, support lawful intercept functionality, and/or perform other processes associated with managing user data.

UDR 240 may store the subscription information obtained and managed by UDM 230. For example, UDR 230 may store subscription information and subscriber profile information obtained by UDM 240. In an exemplary implementation, UDM 230 and/or UDR 240 may provide subscriber information to PCF 220 associated with establishing an AM policy association and UE policy association information when a UE device 110 is registering, as described in detail below. In some implementations, UDM 230 and UDR 240 may be co-located and/or combined as a single device/network element.

Environment 100 illustrated in FIG. 2 may include additional elements and/or NFs that are not illustrated. Such elements and/or NFs may provide security, authentication and authorization, network polices, subscriber profiles, network slicing, and/or facilitate the operation of core network 130. It should also be understood that functions described as being performed by various elements in FIG. 2, including elements in core network 130, may be performed by other elements/functions in other implementations.

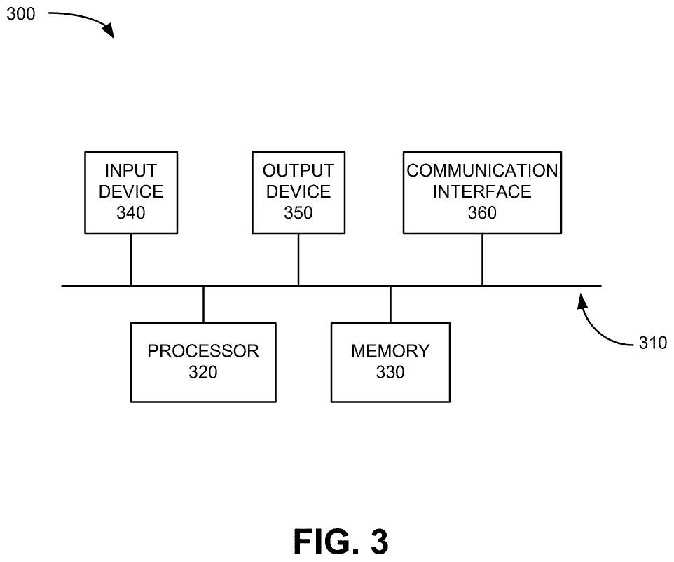

FIG. 3 illustrates an exemplary configuration of a device 300. One or more devices 300 may correspond to or be included in devices in environment 100, such as UE device 110, wireless station 122, network devices 140, such as AMF 210, PCF 220, UDM 230, UDR 240 and other devices included in environment 100. Referring to FIG. 3, device 300 may include bus 310, processor 320, memory 330, input device 340, output device 350 and communication interface 360. The exemplary configuration illustrated in FIG. 3 is provided for simplicity. It should be understood that device 300 may include more or fewer components than illustrated in FIG. 3.

Processor 320 may include one or more processors, microprocessors, or processing logic that may interpret and execute instructions. Memory 330 may include a random access memory (RAM) or another type of dynamic storage device that may store information and instructions for execution by processor 320. Memory 330 may also include a read only memory (ROM) device or another type of static storage device that may store static information and instructions for use by processor 320. Memory 330 may further include a solid state drive (SSD). Memory 330 may also include a magnetic and/or optical recording medium (e.g., a hard disk) and its corresponding drive.

Input device 340 may include a mechanism that permits a user to input information, such as a keypad, a keyboard, a mouse, a pen, a microphone, a touch screen, voice recognition and/or biometric mechanisms, etc. Output device 350 may include a mechanism that outputs information to the user, including a display (e.g., a liquid crystal display (LCD)), a speaker, etc. In some implementations, device 300 may include a touch screen display may act as both an input device 240 and an output device 350.

Communication interface 360 may include one or more transceivers that device 300 uses to communicate with other devices via wired, wireless or optical mechanisms. For example, communication interface 360 may include one or more radio frequency (RF) transmitters, receivers and/or transceivers and one or more antennas for transmitting and receiving RF data. Communication interface 360 may also include a modem or an Ethernet interface to a LAN or other mechanisms for communicating with elements in a network.

In an exemplary implementation, device 300 performs operations in response to processor 320 executing sequences of instructions contained in a computer-readable medium, such as memory 330. A computer-readable medium may be defined as a physical or logical memory device. The software instructions may be read into memory 330 from another computer-readable medium (e.g., a hard disk drive (HDD), SSD, etc.), or from another device via communication interface 360. Alternatively, hard-wired circuitry may be used in place of or in combination with software instructions to implement processes consistent with the implementations described herein. Thus, implementations described herein are not limited to any specific combination of hardware circuitry and software.

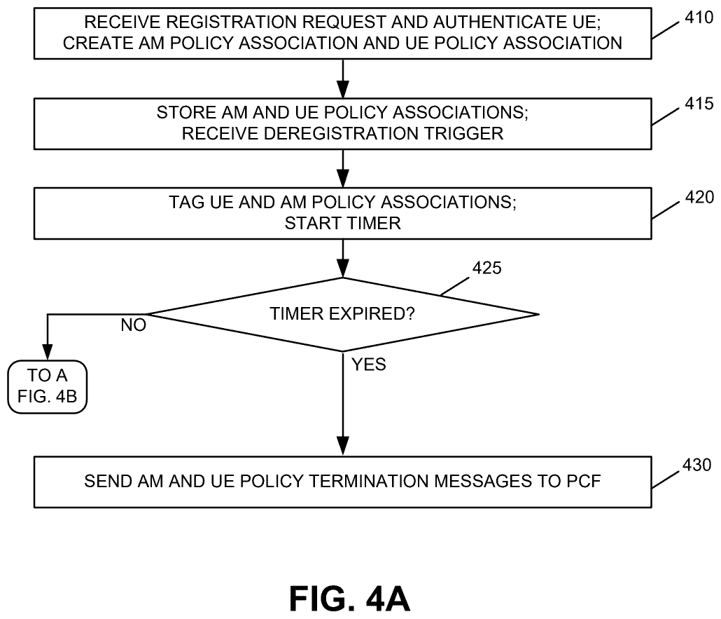

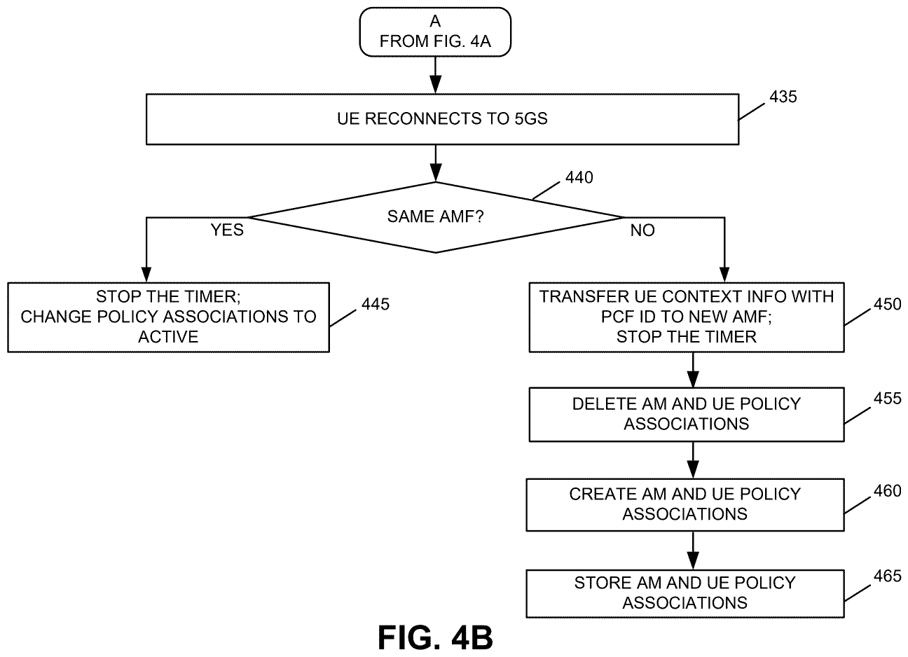

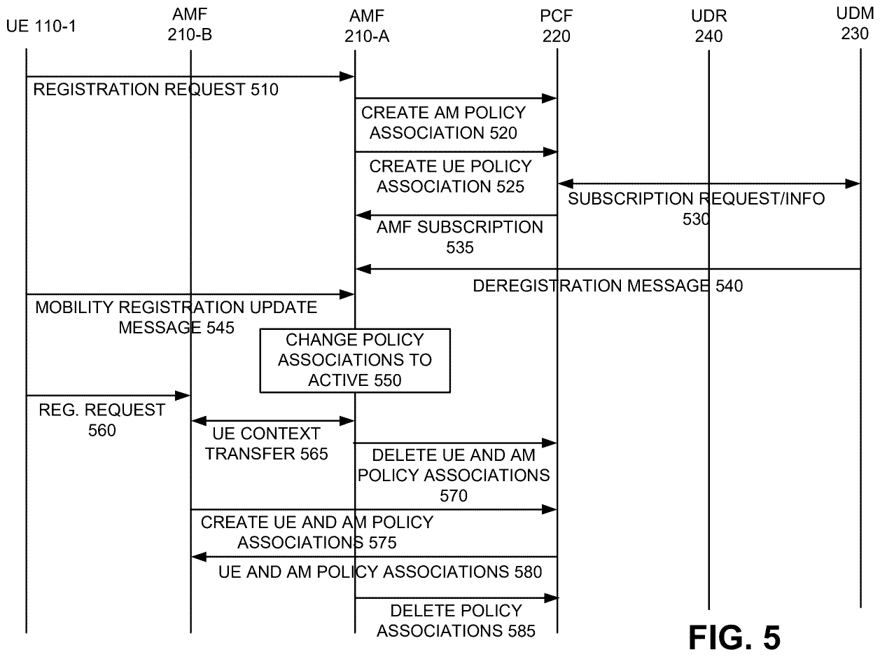

FIGS. 4A and 4B are flow diagrams illustrating processing associated with AM and UE policy association establishments and maintenance in accordance with an exemplary implementation. FIG. 5 is a signal flow diagram illustrating exemplary signal flows associated with the processing of FIGS. 4A and 4B. Processing may begin with a UE device 110 transmitting a registration request and access network 120 (not shown in FIG. 5) receiving and forwarding the registration request (FIG. 5, 510). For example, UE 110-1 may transmit a registration request for a connection and wireless station 122-1 may receive the registration request and forward the registration request to an AMF 210 (e.g., AMF 210-A).

AMF 210-A may receive the registration request and perform authentication associated with registering UE 110-1 (FIG. 4A, block 410). For example, AMF 210-A may determine if UE 110-1 is authorized to establish a data session, such as whether UE 110-1 is associated with a subscriber to core network 130. For this example, assume that UE 110-1 is authenticated.

AMF 210-A may determine that an AM policy association and UE policy association are to be generated for the network connection. For example, in some implementations, AMF 210-A may retrieve subscription information from UDM 230 and/or UDR 240 and determine that an AM policy association indicator and a UE policy association indicator are included with the subscription information associated with UE 110-1.

For example, UDR 240 may store an AM policy association indication that indicates that an AM policy association and a UE policy association are to be established for particular UE devices 110, such as UE devices 110 associated with premium subscribers, UE devices 110 associated with subscribers having a particular QoS, SLA requirements, etc. In each case, UDR 240 may provide the subscriber data and the AM and UE policy association indication (e.g., an AM and UE policy association information elements (IEs)) for UE 110-1 to PCF 220, which may forward the information to AMF 210-A. In this example, assume that an AM policy association and a UE policy association are to be established for the 5G network session for UE 110-1.

In an exemplary implementation, AMF 210-A may send a create AM Policy Association request message and a create UE policy association message to PCF 220 (FIG. 5, 520 and 525). PCF 220 may receive the AM and UE policy association request messages and generate an AM policy association and UE Policy association based on subscription information associated with UE 110-1 obtained from UDM 230 (block 410; FIG. 5, 530).

After generating the AM policy association and UE policy association, PCF 220 may transmit AMF subscription information to AMF 210-1 that includes the AM and UE policy associations (FIG. 5, 535). AMF 210-A receives the AM and UE policy associations and stores the AM and UE policy associations locally at AMF 210-1 (block 415). AMF 210-1 may also send a Registration accept message to UE 110-1 indicating the Registration is accepted (not shown in FIG. 5). In this scenario, assume that the UE device 110-1 data session (e.g., protocol data unit (PDU) session) is established in accordance with the UE and AM policy associations stored in AMF 210-A.

Further assume that after the 5G session has been established and is active, AMF 210-A receives a message from UDM 230 indicating that UE 110-1 is moving from the 5GS/connection to a 4G system/connection, such as a 4G LTE connection (e.g., moving from an area in which the 5G connection is available to an area in which only a 4G LTE connection is available). In an exemplary implementation, UDM 230 may transmit a deregistration message to AMF 210-A (e.g., a callback deregistration message) indicating that UE 110-1 is moving from a 5G connection to a 4G LTE connection based on movement/mobility associated with UE 110-1 (FIG. 5, 540). AMF 210-A receives the deregistration message and tags or marks the UE and AM policy association information stored in AMF 210-A as “transient” (blocks 415 and 420). AMF 210-A may also keep UE device 110-1 context information associated with the data session with a de-registered state indicator. AMF 210-A may also start a timer (e.g., a configurable timer) at AMF 210-A associated with the transient designation for the AM and UE Policy associations, as well as the de-registered designation for the UE context information (block 420). The timer may be modified by a network operator based on real world data associated with the operation, performance and efficiency of network environment 100, as well as the amount of 5G service area in environment 100, as described in detail below. By tagging the AM and UE policy associations as transient, AMF 210-A may defer sending policy association termination messages to PCF 220 or other NFs to a later time, or avoid sending any policy association termination messages at all, as described in detail below.

Assume that prior to the timer at AMF 210-A expiring (block 425—no), UE 110-1 reconnects to the 5GS (FIG. 4B, block 435). In this situation, the reconnection to the 5GS may be with the same AMF 210-A or with a different AMF 210 (e.g., AMF 210-B). In most circumstances, UE 110-1 would be more likely to reconnect with the same AMF 210 with which it previously connected. For example, assume that the same AMF 210 (e.g., AMF 210-A in this example) receives a mobility registration update message from UE 110-1 (FIG. 4B, block 440 yes; FIG. 5, 545). In this case, AMF 210-A receives the mobility registration update message and stops the timer (block 445). AMF 210-A also changes the AM and UE policy association information previously stored in AMF 210-A and marked as “transient” to “active” (block 445; FIG. 5, 550). In this manner, AMF 210-A may avoid signaling PCF 220 and/or other NFs to delete AM and UE policy associations for UE 110-1 when UE 110-1 moves/switches from a 5GS to a 4G network connection, as well as may avoid performing processing associated with creating new AM and UE policy associations when UE 110-1 moves back to the 5GS.

Returning back to block 440, if UE 110-1 when reconnecting to the 5GS sends a Registration request message to a different AMF (e.g., AMF 210-B) (block 440—no; FIG. 5, 560), the receiving AMF 210 (AMF 210-B in this example) sends a UE context transfer message to AMF 210-A (FIG. 5, 565). AMF 210-A receives the context transfer message and forwards UE context information associated with the previous 5GS connection, including the PCF ID associated with PCF 220, to the new AMF (e.g., AMF 210-B in this example) (block 450). AMF 210-A also stops the timer at AMF 210-A and deletes the AM and UE policy associations stored locally on AMF 210-A (blocks 450 and 455).

AMF 210-A may also signal PCF 220 to delete the AM and UE policy associations previously stored at PCF 220 (FIG. 5, 570). AMF 210-B may also send a create AM policy association and a create UE policy association message to PCF 220 (FIG. 5, 575). PCF 220 may generate the AM and UE policy associations in a similar manner as that described above with respect to block 410 (block 460). PCF 220 may also forward the AM and UE policy associations to AMF 210-B (FIG. 5, 580). AMF 210-B receives the AM and UE policy associations and stores the policy associations locally at AMF 210-B (block 465). In this manner, AMF 210-B may receive transferred context information and other information associated with AM and UE policy associations from AMF 210-B when UE 110-1 reverts back to the 5GS.

Returning back to FIG. 4A, if the timer at AMF 210-A expires before UE 110-1 reconnects to the 5GS (block 425—yes) (e.g., before AMF 210-A receives a mobility registration update message from UE 110-1 or receives a context transfer request from another AMF 210), AMF 210-A may send a delete AM and UE policy association deletion message(s) to PCF 220 to delete the AM and UE policy associations stored in PCF 220 (FIG. 4A, block 430; FIG. 5, 585). AMF 210-A may also delete the AM and UE policy associations stored locally at AMF 210-A.

As described above, AMF 210-A may start a configurable timer in response to receiving a de-registration message associated with a session for UE 110-1. In some implementations, the service provider associated with operating environment 100 may modify the duration of the timer based on network conditions.

For example, the service provider may obtain statistics associated with UE devices 110 transitioning from a 5GS to a 4GS (e.g., an EPS) and back to the 5GS. The service provider may analyze the statistics, including performance and network efficiency, and also consider the amount of 5G coverage in environment 100 and whether the amount of 5G coverage is increasing. The service provider may also use artificial intelligence (AI), machine learning (ML) or other techniques to aid in analyzing the statistics and determine a likely period of time in which a UE 110 may transition from the 5GS to the 4GS and back to the 5GS. The service provider may then set the configurable timer at AMF 210 to the period of time in which a UE 110 would be expected to transition back from the 4GS to the 5GS. For example, the period of time in which a typical UE 110 may toggle from a 5GS to a 4GS and back to the 5GS may range from about one second to about 15 seconds. Based on current network data/statistics, if the service provider determines that UEs 110 have been toggling back from 4GS to the 5GS after about 14 seconds, the service provider may modify the timer value from, for example, two seconds to about 14-15 seconds. In this manner, environment 100 is adaptable based on current real-time data associated with operating network environment 100. It should be understood that the above durations of the configurable timer are exemplary only and the configurable timer at AMF 210 may be set to shorter or longer durations (e.g., less than two seconds and greater than 15 seconds) based on the particular environment and operating conditions.

Implementations have been described above with AMF 210-A establishing AM and UE policy associations in connection with other NFs in core network 130. In other implementations, other NFs and/or elements may interface with AMF 210-A to aid in storing and maintaining AM and UE policy associations while a UE 110 is switching from 5G connections to a 4G connection and back to the 5G connection.

Implementations described herein provide for establishing and maintaining an AM policy association and a UE policy association for UE devices 110 that may be switching from one network connection to another network connection and back. By marking the policy association as transient, various network signaling may be reduced, and re-generating the policy associations may also be avoided in many scenarios. This allows the service provider to avoid extra signaling overhead and reduce delays in establishing/re-establishing policy associations.

The foregoing description of example implementations provides illustration and description, but is not intended to be exhaustive or to limit the embodiments to the precise form disclosed. Modifications and variations are possible in light of the above teachings or may be acquired from practice of the embodiments.

For example, features have been described with respect to generating and maintaining UE and AM policy association decisions using elements in core network 130. In other implementations, similar processing may be performed in other portions of environment 100, such as in a Multi-access Edge Computing (MEC) platform located, for example, between access network 120 and core network 130.

Further, features have been described above with respect to a UE 110-1 toggling between a 5GS and 4GS and back to the 5GS. In other implementations, UE 110-1 may toggle between other systems/network connections, such as a 6G system (6GS) to a 5GS and back to the 6GS.

Still further, while series of acts have been described with respect to FIGS. 4A and 4B and signal flows with respect to FIG. 5, the order of the acts and signal flows may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, by a first access and mobility management function (AMF), a first message associated with a de-registration of a user equipment (UE) device from a first network;
maintaining policy association information associated with the UE device and the first network;
receiving, by the first AMF or a second AMF and within a predetermined period of time after the first message is received, a second message indicating that the UE device is re-connecting with the first network; and
modifying, in response to the first AMF receiving the second message, the policy association information to indicate that the policy association information is active.

2. The method of claim 1, wherein the policy association information comprises UE policy association information and access and mobility (AM) policy association information.

3. The method of claim 1, further comprising:
storing, by the first AMF, context information associated with a data session for the UE device with the first network; and
transferring, in response to the second AMF receiving the second message, at least some of the context information associated with the data session from the first AMF to the second AMF.

4. The method of claim 3, wherein the context information comprises a policy control function (PCF) identifier (ID).

5. The method of claim 4, further comprising:
deleting, by the first AMF and in response to the second AMF receiving the second message, the policy association information stored at the first AMF.

6. The method of claim 1, wherein the second message comprises a mobility registration update message or a registration request message.

7. The method of claim 1, wherein the maintaining policy association information comprises:
maintaining, in memory, at least one of access and mobility (AM) policy association information or UE policy association information associated with a connection from the UE device to the first network, wherein the first network comprises a Fifth Generation (5G) network.

8. The method of claim 7, wherein the maintaining policy association information further comprises:
marking the AM policy association information and the UE policy association information associated with the connection with the first network as transient.

9. The method of claim 1, further comprising:
deleting the policy association information in response to not receiving the second message within the predetermined period of time.

10. The method of claim 1, further comprising:
modifying, by a service provider associated with the first network, the predetermined period of time based on data associated with a plurality of UE devices connecting with the first network.

11. A system, comprising:
at least one device including a memory, the at least one device configured to:
generate policy association information associated with a user equipment (UE) device data session with a first network,
receive a first message associated with a de-registration of the UE device from the first network,
maintain, in the memory and in response to receiving the first message, policy association information associated with the UE device and the first network,
receive, within a predetermined period of time after the first message is received, a second message indicating that the UE device is re-connecting with the first network, and
modify, in response to receiving the second message, the policy association information to indicate that the policy association information is active.

12. The system of claim 11, wherein the at least one device comprises an access and mobility management function (AMF), and wherein the policy association information comprises UE policy association information and AM policy association information.

13. The system of claim 11, wherein the at least one device comprises a first AMF and a second AMF, wherein the first AMF is configured to:
transfer context information associated with the data session for the UE device from the first AMF to the second AMF.

14. The system of claim 13, wherein the context information comprises a policy control function (PCF) identifier (ID).

15. The system of claim 11, wherein the at least one device comprises a first AMF and a second AMF, wherein the second message comprises a mobility registration update message or a registration request message, and the second message is received by the first AMF or the second AMF.

16. The system of claim 11, wherein when maintaining policy association information, the at least one device is configured to:
maintain at least one of access and mobility (AM) policy association information or UE policy association information associated with a connection from the UE device to the first network, wherein the first network comprises a Fifth Generation (5G) network.

17. The system of claim 16, wherein when maintaining policy association information, the at least one device is further configured to:
mark the AM policy association information and the UE policy association information associated with the connection with the first network as transient.

18. The system of claim 11, wherein the at least one device comprises:
a processing device associated with a service provider associated with the first network, wherein the processing device is configured to:
modify the predetermined period of time based on data associated with a plurality of UE devices connecting and re-connecting with the first network.

19. A non-transitory computer-readable medium having stored thereon sequences of instructions which, when executed by at least one processor, cause the at least one processor to:
store policy association information associated with a user equipment (UE) device data session with a first network;
receive a first message associated with a de-registration of the UE device from the first network;
maintain policy association information associated with the UE device and the first network;
receive, within a predetermined period of time after the first message is received, a second message indicating that the UE device is re-connecting with the first network; and
modify, in response to receiving the second message, the policy association information to indicate that the policy association information is active.

20. The non-transitory computer-readable medium of claim 19, wherein when maintaining policy association information, the instructions cause the at least one processor to:
store access and mobility (AM) policy association information and UE policy association information associated with the UE device data session with the first network, wherein the first network comprises a Fifth Generation (5G) network;
mark the stored AM policy association information and UE policy association information as transient; and
maintain the stored AM policy association and UE policy association in memory for a configurable period of time.
